(19) United States
(12) Patent Application Publication
(10) Pub. No.: US 2011/0102072 A1
(43) Pub. Date: May 5, 2011

(54) Power management of an integrated circuit

(75) Inventors: Sachin Satish Idgunji, San Jose, CA (US); David Walter Flynn, Cambridge (GB); John Philip Biggs, Teversham (GB)

(73) Assignee: ARM LIMITED, Cambridge (GB)

(21) Appl. No.: 12/591,017

(22) Filed: Nov. 4, 2009

(51) Int. Cl. G05F 1/10

(52) U.S. Cl. 327/540

(57) ABSTRACT

An integrated circuit 2 includes logic circuitry 4 connected to virtual power rails 6, 8. These virtual power rails are connected via power control transistors 10, 16 to a power supply 14. A power controller 20 produces control signals which determines a number of the power control transistors 10, 16 which are in a conductive state and accordingly controls the virtual power rails to have an intermediate voltage level. The intermediate voltage level may be selected to hold the logic circuitry in a retention mode in which state is retained in the logic circuitry 4, but processing operations are not performed. When the functional mode is re-entered, all of the header and footer transistors 10, 16 may be switched to the conductive state.

### BACKGROUND OF THE INVENTION

1. Field of the Invention

This invention relates to the field of integrated circuits. More particularly, this invention relates to the management of power consumption within integrated circuits.

2. Description of the Prior Art

It is known to provide integrated circuits including power rails connected via header and footer transistors to virtual power rails. The logic circuitry within the integrated circuit draws it power from the virtual power rails. The header and footer transistors, which are typically high threshold voltage transistors, are used to isolate the virtual power rails from the main power rails in low power states and accordingly isolate the logic circuitry from the power supply. This is a useful technique in reducing power consumption of the integrated circuit, e.g. by reducing the static leakage current through the integrated circuit.

In addition to being able to place portions of an integrated circuit into a low power state, it is desirable that such portions be able to resume processing activity rapidly when they leave this low power state. In order to assist in this, the state variables of the logic circuitry should be preserved through the low power state. One way of achieving this is to save the state variables into balloon latches. However, the provision of balloon latches does increase the circuit overhead.

### SUMMARY OF THE INVENTION

Viewed from one aspect the present invention provides an integrated circuit comprising:

a plurality of power control transistors coupled to a virtual power rail to couple said virtual power rail to a power supply having a source voltage level;

a power controller coupled to said plurality of power control transistors and configured to control conduction through said plurality of power control transistors; and

logic circuitry coupled to said virtual power rail to draw power therefrom; wherein

said power controller selects a first number of said power control transistors to switch to a conductive state and a second number of said power control transistors to switch to a non-conductive state so as to maintain said virtual power rail at an intermediate voltage level.

The present technique recognises that by using a power controller to select the number of power control transistors which couple a virtual power rail to the power supply, the virtual power rail may be held at an intermediate voltage level and accordingly the power consumed by the logic circuitry can be reduced whilst the logic circuitry is supplied with sufficient power that retains its state. The power controller selects a first number of the power control transistors to switch a conductive state and a second number of the power control transistors to switch to a non-conductive state so as to maintain the virtual power rail at the intermediate voltage level. The selection of which power control transistors are on and which are off is substantially static and accordingly power is not consumed in dynamically modulating the conduction through the power control transistors as this would itself consume an undesirable amount of power, e.g. in rapidly time-varying control signals.

While the present technique could be used with integrated circuits to switch them between different operating voltage levels, all of which would be functional mode levels in which digital processing operations were performed, the present technique is well suited to use in systems in which the power controller is responsive to a power control signal to switch the integrated circuit between a functional mode and a retention mode which the logic circuitry holding state without performing digital processing operations.

The control of the power control transistors by the power controller may be achieved in an efficient manner by dividing the plurality of power control transistors into a plurality of sets of power control transistors, each set of power control transistors being switched between the conductive state and the non-conductive state by a power control signal shared within the set. Thus, the routing overhead of control signals is reduced since a single power control signal can switch a full set of power control transistors.

Controlling the number of power control transistors in the conductive state at an appropriate level to achieve a desired intermediate voltage may be facilitated in embodiments in which at least some of the different sets of power control transistors contain differing number of power control transistors. Thus, different combinations of sets of power control transistors being placed into the conductive state will vary the drive strength to the virtual power rail and thus the intermediate voltage level that is achieved.

This ability to select which sets of power control transistors are conductive and accordingly arrive at a desired intermediate voltage level is facilitated when the plurality of sets of power control transistors contain monotonically increasing numbers of power control transistors. This enables a wide range of values of the first number of power control transistors that are in the conductive state to be achieved.

The different sets of power control transistors can be organised into groups with these groups sharing the same number of power control transistors within their member sets. The groups could share a common power control signal with all the sets within a group being switched on and switched off together.

A convenient scaling of the number of power control transistors in the different groups that enables an exponential increase in the number of power control transistors in the on state to be achieved with an appropriate coded power control signal is one in which the different groups of power control transistors contain a number of elements that increases by a factor of four between groups.

More generally, such exponential relationship between the number of power control transistors within sets of different groups is provided when each set contains X power control transistors where X is an integer portion of M^{N}, M is a positive integer and N increases between groups.

The control applied by the power controller could be open loop control in which the power controller sets the first number and the second number at predetermined values. The power controller may be seeking to maintain the intermediate voltage at a target level and such open loop control may be arranged in advance such that the intermediate voltage will lie close to the target level.

More accurate control of the intermediate voltage level can be achieved when the power controller senses the intermediate voltage level and applies feedback control to the first number and the second number in order to maintain the intermediate voltage level at the target level.

Such feedback control is well suited to dealing with individual variations between integrated circuits and also to time varying parameters such as overall supply voltage variation, temperature variation, circuit ageing and the like.

The power control transistors could directly connect to a power source. However, routing of power signals is easier if the power control transistors connect between the virtual power rail and a power rail, which itself then couples to the power source.

The power control transistors may be provided as either or both of header transistors and footer transistors to the logic circuitry.

Power consumption is further reduced in the logic circuitry if the logic circuitry is responsive to a clock input signal and holds state when the clock input signal is static. Thus, when the intermediate voltage level is applied, the clock input signal may be stopped and power consumption within the logic circuitry reduced while state is maintained.

Viewed from another aspect the present invention provides an integrated circuit comprising:

a plurality of power control transistor means coupled to a virtual power rail for coupling said virtual power rail means to power supply means having a source voltage level;

power controller means coupled to said plurality of power control transistor means for controlling conduction through said plurality of power control transistor means; and

logic means coupled to said virtual power rail means to draw power therefrom; wherein

said power controller means selects a first number of said power control transistor means to switch to a conductive state and a second number of said power control transistor means to switch to a non-conductive state so as to maintain said virtual power rail means at an intermediate voltage level.

Viewed from a further aspect the present invention provides a method of operating an integrated circuit, said method comprising the steps of:

coupling a virtual power rail to a power supply having a source voltage level via a plurality of power control transistors;

controlling conduction through said plurality of power control transistors with a power controller;

drawing power for logic circuitry from said virtual power rail; and

selecting a first number of said power control transistors to switch to a conductive state and a second number of said power control transistors to switch to a non-conductive state so as to maintain said virtual power rail at an intermediate voltage level.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 schematically illustrates an integrated circuit including power management mechanisms;

FIG. 2 is a table showing a relationship between groups, sets and numbers of power control transistors;

FIG. 3 schematically illustrates an integrated circuit showing power control transistors distributed through the integrated circuit;

FIG. 4 is a signal diagram showing different virtual rail voltages and currents with different numbers of power control transistors in the conductive state;

FIG. 5 is a graph showing the relationship between the virtual rail voltage and the effective width of the power control transistors which are in the conductive state;

FIG. 6 is a graph showing the relationship between the leakage current through the logic circuitry and the effective width of the power control transistors in the conductive state;

FIGS. 7 and 8 illustrate the relationship between the number of power control transistors selected to the conductive state and a binary coded signal for controlling the power control transistors; and

FIG. 9 is a flow diagram schematically illustrating a method of power management.

### DESCRIPTION OF THE PREFERRED EMBODIMENTS

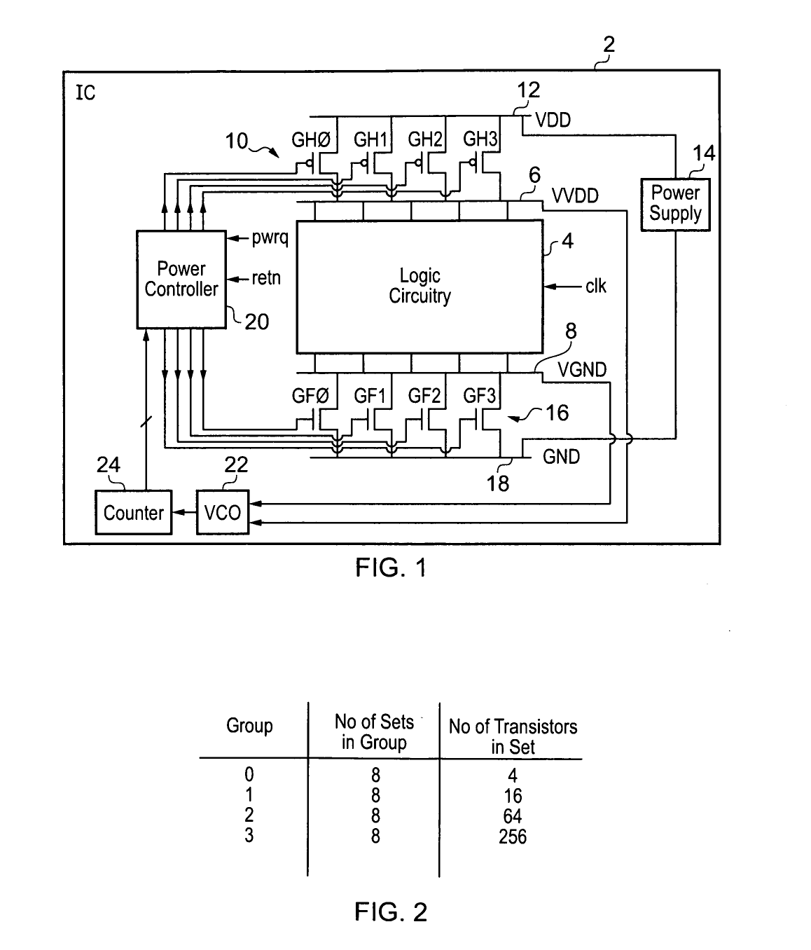

FIG. 1 schematically illustrates an integrated circuit 2 including logic circuitry 4 connected to a virtual supply rail 6 and a virtual ground rail 8. The virtual supply rail 6 is connected via power control header transistors 10 to a supply rail 12, which in turn connects to a power supply 14. The virtual ground rail 8 is connected via power control footer transistors 16 to a virtual ground rail 18 that again connects to the power supply 14.

A power controller 20 generates control signals supplied to the power control header transistors 10 and the power control footer transistors 16 to select which ones of these are in a conductive state or a non-conductive state. It will be appreciated that the non-conductive state will not mean that absolutely no current flows through the transistor, as there will always be some residual amount of leakage, rather that the transistor is substantially switched off. The power control header transistors 10 and the power control footer transistors 16 are shown as labelled GH0, GH0, GH1, GH2, GH3 and GF0, GF1, GF2 and GF3 respectively. Each of the individual transistors illustrated in FIG. 1 may be considered to correspond to a group of transistors which itself may contain multiple sets of transistors. These transistors may be distributed through the logic circuitry 4 in order to feed the virtual supply rails of the power grid which passes through the logic circuitry 4. Nevertheless, the depiction of FIG. 1 schematically illustrates the arrangement and the nature of the control of the power control transistors.

The power controller 20 is responsive to a power request signal pwrq and a retention signal retn to switch between a functional mode of operation and a retention mode of operation. In the functional mode of operation, the logic circuitry 4 is clocked by a clock input signal clk and performs digital processing operations. In the retention mode, the voltage difference between the virtual supply rail 6 and the virtual ground rail 8 is reduced and the clock input signal is stopped. In this retention mode the logic circuitry 4 holds its state values, but does not perform digital processing operations.

The reduced voltage supplied to the logic circuitry 4 in retention mode reduces the leakage current in the logic circuitry 4 and accordingly the power consumption of the integrated circuit 2. The continued storage of the state of the logic circuitry 4 within the logic circuitry 4 has the consequence that when the full supply voltage is returned to the logic circuitry 4 in the functional mode, digital processing operations may be more rapidly resumed.

It will be seen that the power controller 20 supplies different power control signals to the gate nodes of the power control header transistors 10 and the power control footer transistors 16. These separate power control signals allow the individual power control header transistors 10 and power control footer transistors 16 to be switched between the conductive state and the non-conductive state. In this way, the power controller 20 can control the power control header transistors 10 and the power control footer transistor 16 such that a first number of these transistors are in the conductive state and a second number of these transistors are in the non-conductive state. The number of transistors which are in the conductive state controls the drive strength (effective total drive transistor width) to the virtual supply rail 6 and the virtual ground rail 8. A potential divider is formed between the supply rail 14 and the ground rail 18 with the power control header transistors 10, the logic circuitry 4 and the power control footer transistor 16 disposed in series therebetween. The relative resistance of these elements in their state in the retention mode controls the potential difference between the virtual supply rail 6 and the virtual ground rail 8. Thus, if fewer of the power control header transistors 10 and the power control footer transistors 16 are conductive, then the higher will be the voltage drop between the supply rail 12 and the virtual supply rail 6 and between the ground rail 18 and the virtual ground rail 8 thereby reducing the voltage difference between the virtual supply rail 6 and the virtual ground rail 8 which supplies the logic circuitry 4. The power control signals to the power control header transistors 10 and the power control footer transistors 16 are substantially static signals which hold their values in the retention mode and accordingly power is not consumed in changing (modulating) the values of these power control signals. If feedback control of the intermediate voltage levels is performed, then some fine tuning of the number of power control transistors 10, 16 which are conductive may be performed to adjust the voltage difference between the virtual supply rail 6 and the virtual ground rail 8 to the desired level.

The feedback mechanism illustrated in FIG. 1 comprises a voltage controlled oscillator 22 which responds to the voltage difference between the virtual supply rail 6 and the virtual ground rail 8 to produce an output signal with a frequency proportional to the voltage difference therebetween. This output signal is supplied to a counter 24 which is reset at a fixed time interval. The count value at the point of reset may be captured and gives a measure of the voltage difference between the virtual supply rail 6 and the virtual ground rail 8. This count value can thus be used by the power controller 20 to fine-tune the number of power control transistors which are switched to the conductive state. This enables variations such as occur with changes in temperature, ageing of the circuit, variations between different instances of the circuit and the like to be accommodated by the control action of the power controller 20 using this feedback mechanism.

FIG. 2 is a table illustrating how the power control transistors are organised into sets and then those sets are organised into groups. As shown in FIG. 2, Group 0 contains eight sets of transistors. Each of the sets of transistors in turn contains four transistors. Group 1 contains eight sets of transistors with each of these sets of transistors containing sixteen transistors. This relationship continues for Groups 2 and 4 with the individual sets increasing by a factor of four in the number of transistors they contain when moving between Groups. This provides an exponential relationship between the group number and the number of transistors in a set of that group. More generally if X is the number of transistors in a set, then X may be given by M^{N}, where M is a positive integer constant and N increases between groups. The transistors within a set, and if desired the transistors within a group, may share a power control signal switching their respective gate nodes. This reduces the number of power control signals which need be generated by the power controller 20 easing routing congestion and reducing the amount of power consumed in the driving power control signals themselves. The variation in the number of transistors within each set permits combinations of sets and groups to be switched into the conductive state to produce an overall total number of conductive power control transistors required to achieve a desired intermediate voltage level.

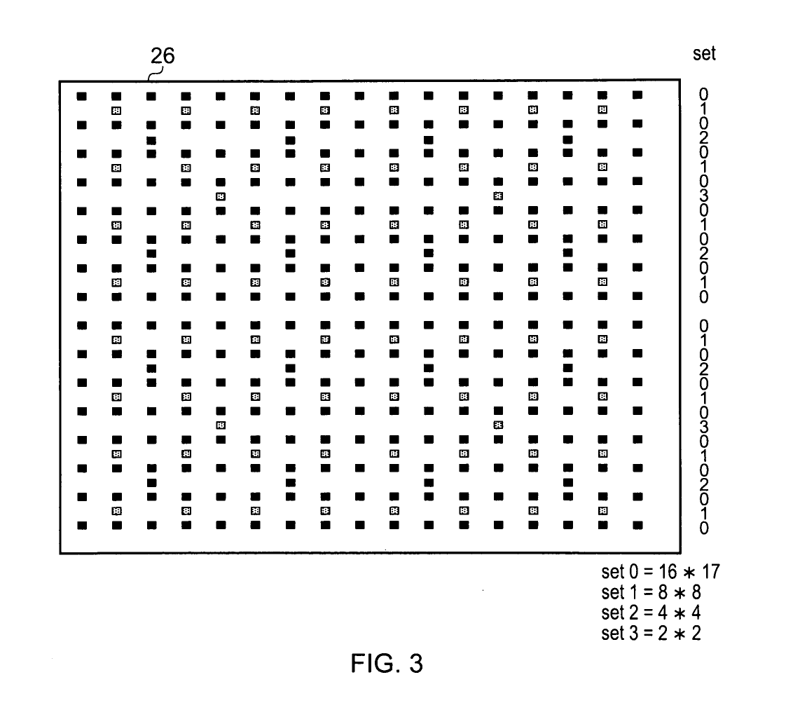

FIG. 3 schematically illustrates an integrated circuit 26 having power control transistors distributed through the integrated circuit 26 to feed its power grid. This type of arrangement will be familiar to those in this technical field whereby the power grid extends through the integrated circuit 26 to provide local power connections for the cells which form the integrated circuit 26.

The power control transistors are each members of a set. The different sets contain different numbers of power control transistors. The right hand edge of the integrated circuit 26 shows an indication of to which set a corresponding row of power control transistors running through the integrated circuit 26 belongs. Set 0 contains the largest number of power control transistors. Set 3 contains the fewest number of power control transistors. The total number of power control transistors in the conductive state may be fine-tuned by combining which of the sets of power control transistors are switched on and which are switched off. This selection can be substantially static, other than, for example, tracking long-term trends, accounting for variations between individual instances of the integrated circuit or variations within the overall power supply voltage.

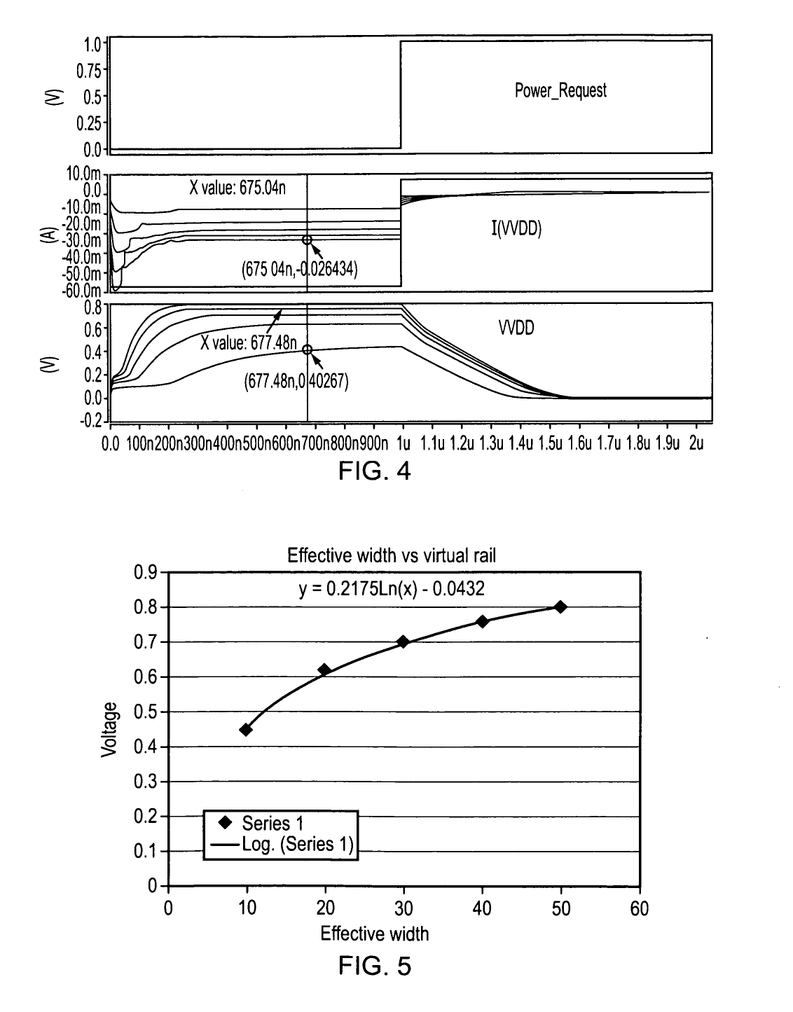

FIG. 4 is a signal diagram illustrating different virtual rail voltage levels and leakage currents through the logic circuitry 4 associated therewith. As will be seen from FIG. 4, there are provided five levels at which the power control transistors may be used to supply an intermediate voltage. When all of the power control transistors are switched on, then the full voltage between the supply rail 12 and the ground rail 18 will be applied subject to a small voltage drop through the power control transistors. The different retention voltage levels illustrated in FIG. 4 respectively correspond to ⅙, ⅓, ½, ⅔ and ⅚ of the total number of power control transistors being turned on. The intermediate voltage levels produced yield a voltage difference between the virtual supply rail 6 and the virtual ground rail 8 respectively being 0.3V, 0.57V, 0.68V, 0.75V and 0.8V.

FIG. 5 illustrates the relationship between the effective width of the power control transistors 10, 16 and the virtual rail voltage (voltage difference between the virtual supply rail 6 and the virtual ground rail 8). The effective width corresponds to the sum of the width of the power control transistors which are in the conductive state. It will be appreciated that all the power control transistors could have the same width, or alternatively different power control transistors may have different widths with different width transistors being members of different sets and groups. If wider transistors are used in a group, then fewer of these wider transistors need be provided in order to achieve provision of the same amount of drive strength to the virtual rails by that group.

As will be seen in FIG. 5, as the effective width of the power control transistors 10, 16 which are conductive is increased, the intermediate voltage increases towards the full rail value.

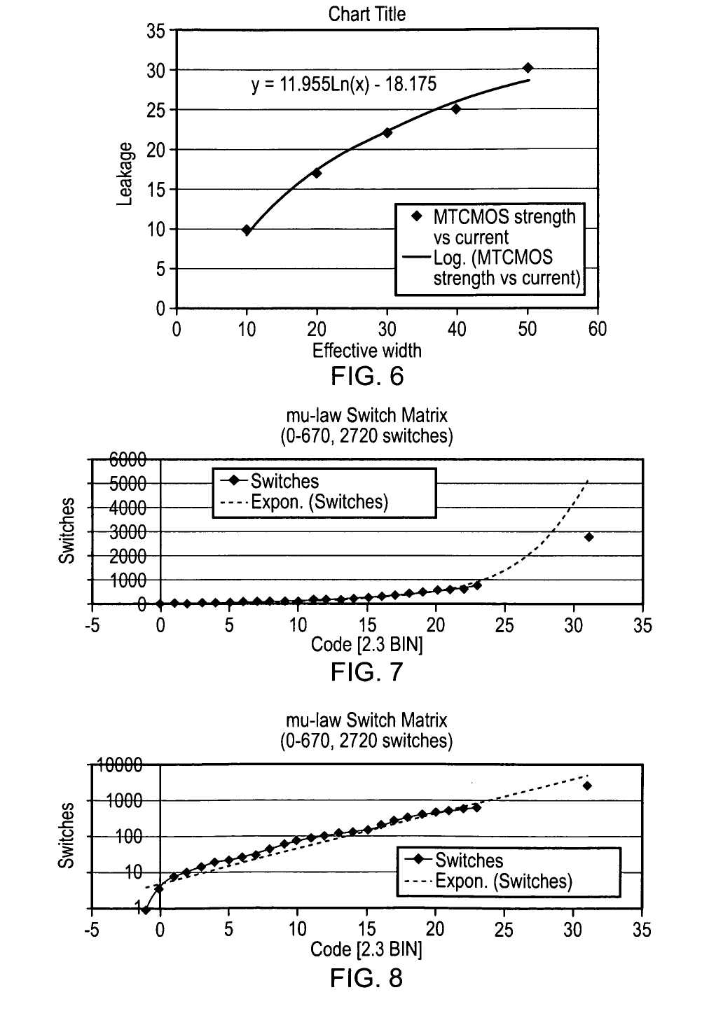

FIG. 6 is similar to FIG. 5 except that the leakage current through the logic circuitry 4 is shown in relationship to the effective width of the number of power control transistors 10, 16 which are conductive. As the number of power control transistors which are conductive is reduced, the voltage difference across the logic circuitry 4 will be reduced and accordingly the leakage current within the logic circuitry 4 will be reduced. This reduces the power consumption of the integrated circuit during the retention mode while permitting the logic circuitry 4 to retain its state values and be ready for a rapid resumption of digital processing operations when the functional mode is re-entered.

FIGS. 7 and 8 illustrate how a 5 bit binary power control signal value may be used to select the number of power control transistors 10, 16 which are conductive. This may be used to achieve an exponential relationship between the binary power control value and the number of switches in a manner well suited to providing a wide range of drive strength to the virtual rails 6, 8.

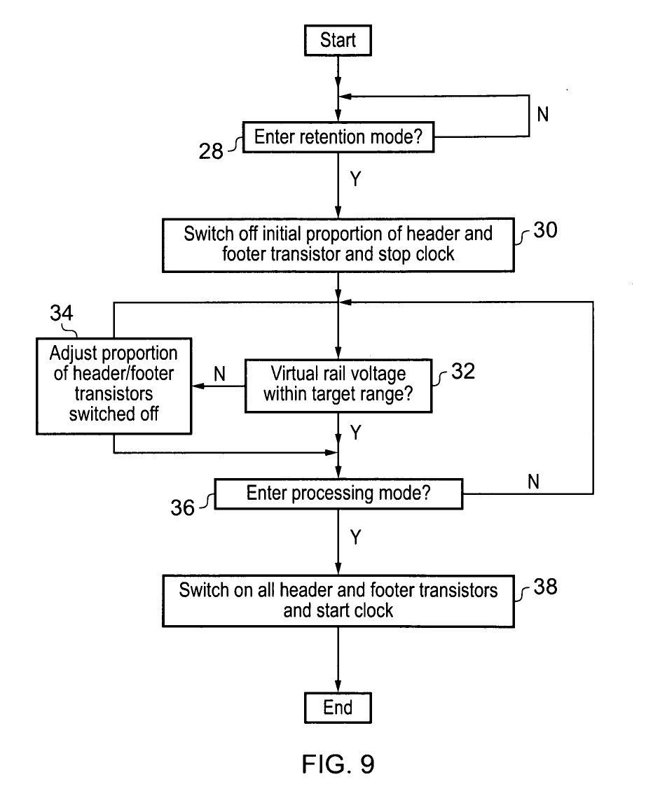

FIG. 9 is a flow diagram schematically illustrating entry to the retention mode and exit from the retention mode of the integrated circuit 2. At step 28, the process waits until a signal triggering entry into the retention mode is received (i.e. the retn signal is received by the power controller 20). Step 30 switches off an initially predetermined proportion of the header and footer transistors 10, 16 as well as stopping the clock input signal clk. This predetermined proportion is set to a value known to approximately yield the desired intermediate voltage level upon the virtual power rails.

Step 32 senses the virtual rail voltage and determines whether or not this is within the desired target range. Step 34 fine-tunes the first number of power control transistors which are in the conductive state in order to move toward the target range if the determination at step 32 was that the virtual rail voltage was not currently within the target range. Thus, the action of step 34 is feedback control adjusting the first number of power control transistors (i.e. the number of power control transistors in the conductive state) to achieve a desired voltage across the logic circuitry 4.

At step 36 a determination is made as to whether or not a signal triggering a return to the functional mode has been received (the pwrq signal received by the power controller 20). If such a signal has not been received, then the integrated circuit 2 remains in the retention mode and processing returns to step 32. When the functional mode is to be re-entered, step 38 switches on all of the header and footer transistors 10, 16 (this may be phased to reduce in rush current) to restore the full rail voltages to the virtual power rails 6, 8 as well as restarting the clock input signal clk. The logic circuitry 4 then resumes digital processing operations.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

1. An integrated circuit comprising:
a plurality of power control transistors coupled to a virtual power rail to couple said virtual power rail to a power supply having a source voltage level, said power control transistors consisting of all P-type transistors or all N-type transistors;
a power controller coupled to said plurality of power control transistors and configured to control conduction through said plurality of power control transistors; and
logic circuitry coupled to said virtual power rail to draw power therefrom; wherein
said power controller selects a first number of said power control transistors to switch to a conductive state and a second number of said power control transistors to switch to a non-conductive state wherein the effective width of the power control transistors can be varied and corresponds to the number of said power control transistors switched into said conductive state so as to support a range of intermediate voltage levels at said virtual power rail.

2. An integrated circuit as claimed in claim 1, wherein said power controller is responsive to a power control signal to switch said integrated circuit between:
(i) a functional mode in which substantially all of said power control transistors are in said conductive mode and said logic circuitry performs digital processing operations; and
(ii) a retention mode is which at least some of said plurality of power control transistors are in said non-conductive state and said logic circuitry operates to hold state without performing digital processing operations.

3. An integrated circuit as claimed in claim 1, wherein said plurality of power control transistors are divided in to a plurality of sets of power control transistors, each set of power control transistors being switched between said conductive state and said non-conductive state by a power control signal shared within said set.

4. An integrated circuit as claimed in claim 3, wherein at least some different ones of said plurality of sets of power control transistors contain differing numbers of said power control transistors.

5. An integrated circuit as claimed in claim 3, wherein at least some different ones of said plurality of sets of power control transistors contain monotonically increasing numbers of said power control transistors.

6. An integrated circuit as claimed in claim 3, wherein said plurality of sets of power control transistors comprises a plurality of groups of sets, each set within a group of sets containing a same number of power control transistors and sets within different groups containing a different number of power control transistors.

7. An integrated circuit as claimed in claim 6, wherein sets within different groups contain a number of power control transistors that increases by a factor of four between groups.

8. An integrated circuit as claimed in claim 6, wherein sets within different groups contain a X power control transistors, where X is an integer portion of M^{N} and, M is a positive constant and N increases between groups.

9. An integrated circuit as claimed in 1, wherein said power controller controls said first number of power control transistors and said second number of power control transistors to maintain said intermediate voltage level at a target level.

10. An integrated circuit as claimed in claim 9, wherein said power controller senses said intermediate voltage level and applies feedback control to said first number of power control transistors and said second number of power control transistors to maintain said intermediate voltage level at a target level.

11. An integrated circuit as claimed in claim 10, wherein said feedback control varies said first number of power control transistors and said second number of power control transistors to maintain said intermediate voltage level as a temperature of said integrated circuit varies.

12. An integrated circuit as claimed in claim 1, comprising a power rail coupled to said power source, said plurality of power control transistors being coupled to said power rail and serving to connect said virtual power rail to said power source via said power rail.

13. An integrated circuit as claimed in claim 1, wherein said plurality of power control transistors include a plurality of header transistors and said virtual power rail is a virtual supply rail.

14. An integrated circuit as claimed in claim 1, wherein said plurality of power control transistors include a plurality of footer transistors and said virtual power rail is a virtual ground rail.

15. An integrated circuit as claimed in claim 1, wherein said logic circuitry is responsive to a clock input signal to perform digital processing operations and to hold state when said clock input signal is static.

16. An integrated circuit comprising:
a plurality of power control transistors, coupled to a virtual power rail, for coupling said virtual power rail to a power supply having a source voltage level, said power control transistors consisting of all P-type transistors or all N-type transistors;
power controller means coupled to said plurality of power control transistors, for controlling conduction through said plurality of power control transistors; and
logic means, coupled to said virtual power rail, for drawing power therefrom; wherein
said power controller means is configured to select a first number of said power control transistors to switch to a conductive state and a second number of said power control transistors to switch to a non-conductive state wherein the effective width of the power control transistors can be varied and corresponds to the first number of said power control transistors switched into said conductive state so as to support a range of intermediate voltage levels at said virtual power rail.

17. A method of operating an integrated circuit, said method comprising the steps of:
coupling a virtual power rail to a power supply having a source voltage level via a plurality of power control transistors, said power control transistors consisting of all P-type transistors or all N-type transistors;
controlling conduction through said plurality of power control transistors with a power controller;
drawing power for logic circuitry from said virtual power rail; and
selecting a first number of said power control transistors to switch to a conductive state and a second number of said power control transistors to switch to a non-conductive state wherein the effective width of the power control transistors can be varied and corresponds to the first number of said power control transistors switched into said conductive state so as to support a range of intermediate voltage levels at said virtual power rail.

18. An integrated circuit comprising:
a plurality of power control transistors coupled to a virtual power rail to couple said virtual power rail to a power supply having a source voltage level;
a power controller coupled to said plurality of power control transistors and configured to control conduction through said plurality of power control transistors; and
logic circuitry coupled to said virtual power rail and configured to draw power therefrom, wherein said power controller selects a first number of said power control transistors to switch to a conductive state and a second number of said power control transistors to switch to a non-conductive state so as to maintain said virtual power rail at an intermediate voltage level, wherein said plurality of power control transistors are divided into a plurality of sets of power control transistors, each set of power control transistors being switched between said conductive state and said non-conductive state by a power control signal shared within said set, wherein at least some different ones of said plurality of sets of power control transistors contain monotonically increasing numbers of said power control transistors.
